(19) United States
(12) Patent Application Publication
(10) Pub. No.: US 2023/0347789 A1
(43) Pub. Date: Nov. 2, 2023

(54) HEAT EXCHANGE SYSTEM AND METHOD OF OPERATING THE SAME

(71) Applicant: THERMO KING LLC, Minneapolis, MN (US)

(72) Inventors: Pavel HOUDEK, Kutna Hora (CZ); Jiri DOUDA, Malesov (CZ)

(21) Appl. No.: 18/308,205

(22) Filed: Apr. 27, 2023

(30) Foreign Application Priority Data
Apr. 27, 2022 (EP) 22170294.7

(51) Int. Cl. B60K 11/02; B60L 58/26

(52) U.S. Cl. CPC B60L 58/26; B60K 11/02; B60K 2001/005

(57) ABSTRACT

There is disclosed a heat exchange system for providing cooling by circulating a coolant, the heat exchange system comprising: a supply circuit for circulating the coolant comprising: a coolant supply heat exchanger for rejecting heat from the coolant to provide a supply of chilled coolant and a supply pump for circulating the coolant in the coolant supply circuit; a load circuit for circulating the coolant, comprising: a cooling load heat exchanger configured to transfer heat to the coolant and a load pump for circulating the coolant in the load circuit; a mixing device which is configured to form part of each of the supply circuit and the load circuit; and a valve arrangement configured to control a mix of (i) coolant from the supply circuit and (ii) recirculated coolant from the load circuit, in a coolant flow provided to the cooling load heat exchanger.

### TECHNICAL FIELD

The present application relates to a heat exchange system for providing cooling by circulating a coolant, and a method of operating the heat exchange system.

### BACKGROUND

The cooling capacity of heat exchange systems having heat rejecting heat exchangers, with a variable temperature of coolant exiting the heat rejecting heat exchanger, is dependent on the temperature of the coolant exiting the heat rejecting heat exchanger and limited by the flow rate which can be achieved including the hydraulic losses incurred in the heat rejecting heat exchangers.

### SUMMARY

According to a first aspect, there is provided a heat exchange system for providing cooling by circulating a coolant, the heat exchange system comprising:
a supply circuit for circulating the coolant comprising:
   a coolant supply heat exchanger for rejecting heat from the coolant to provide a supply of chilled coolant;
   a supply pump for circulating the coolant in the coolant supply circuit; a load circuit for circulating the coolant, comprising:
   a cooling load heat exchanger configured to transfer heat to the coolant;
   a load pump for circulating the coolant in the load circuit;
a mixing device which is configured to form part of each of the supply circuit and the load circuit; and
a valve arrangement configured to control a mix of (i) coolant from the supply circuit and (ii) recirculated coolant from the load circuit, in a coolant flow provided to the cooling load heat exchanger.

The load circuit or the supply circuit may comprise the valve arrangement. The expression “coolant from the supply circuit” is intended to refer to coolant provided to the mixing device from the coolant supply heat exchanger (i.e. without intervening circulation through the load circuit). The expression “recirculated coolant from the load circuit” is intended to refer to coolant provided from the cooling load heat exchanger without intervening circulation through the supply circuit.

The heat exchange system may be configured to operate with a supply recirculation condition in the mixing device, whereby at least a portion of coolant circulated by the supply pump follows a supply circuit recirculation loop extending through the mixing device. The heat exchange system may be configured to operate with a load recirculation condition in the mixing device, whereby at least a portion of coolant circulated by the load pump follows a load circuit recirculation loop extending through the mixing device.

It may be that the mixing device comprises: a supply circuit inlet for receiving chilled coolant from the supply circuit; a supply circuit outlet for providing coolant to the supply circuit for recirculation to the coolant supply heat exchanger; a load circuit inlet for receiving coolant from the load circuit; a load circuit outlet for providing coolant to the load circuit for heat transfer at the cooling load heat exchanger.

It may be that the heat exchange system is configured so that in use there is an equal flow rate of coolant through the supply circuit inlet and the supply circuit outlet (which may correspond to a minimum prevailing flow rate in the supply circuit). It may be that the heat exchange system is configured so that in use there is an equal flow rate of coolant through the load circuit inlet and the load circuit outlet (which may correspond to a minimum prevailing flow rate in the load circuit).

It may be that the mixing device is configured so that in use coolant drawn through the load circuit outlet preferentially originates from the supply circuit inlet, up to a flow rate of coolant flowing through the supply circuit inlet. It may be that the mixing device is configured so that in use coolant drawn through the supply circuit outlet preferentially originates from the load circuit inlet.

The mixing device may be configured so that in use coolant provided to the mixing device from the supply circuit inlet preferentially flows to the load circuit outlet, up to a flow rate of coolant through the load circuit outlet. The flow rate of coolant through the load circuit outlet may be defined as a minimum prevailing flow rate in the load circuit, Q₂. The expression “minimum prevailing flow rate” is used as it should be appreciated that parts of the load circuit away from the load circuit outlet may have a higher flow rate, Q_{L}, for example owing to an additional recirculating flow within a sub portion of the respective circuit.

The mixing device may be configured so that in use coolant provided to the mixing device from the load circuit inlet preferentially flows to the supply circuit outlet, up to a flow rate of coolant through the supply circuit outlet. The flow rate of coolant through the supply circuit outlet may be defined as a minimum prevailing flow rate in the supply circuit, Q₁.

It may be that the mixing device has a flow pathway between two opposing ends and is configured to permit flow in both directions along the flow pathway. It may be that a supply recirculation path from the supply circuit inlet to the supply circuit outlet is along a first direction along the flow pathway. It may be that a load recirculation path from the load circuit inlet to the load circuit outlet is along a second direction along the flow pathway. It may be that the supply recirculation path and the load recirculation flow path overlap along the flow pathway.

The heat exchange system may be configured to operate with a supply recirculation condition in the mixing device, whereby there is a net positive flow along the supply recirculation path in the mixing device. The heat exchange system may be configured to operate with a load recirculation condition in the mixing device, whereby there is a net positive flow along the load recirculation path in the mixing device.

It may be that the mixing device has a flow pathway between two opposing ends, wherein the supply circuit inlet and the load circuit outlet are relatively closer to a first end. It may be that the supply circuit outlet and the load circuit inlet are relatively closer to the opposing second end.

It may be that the mixing device has a bidirectional portion for flow of coolant in either direction, and wherein the mixing device is configured so that a flow rate and flow direction along the bidirectional portion corresponds to a difference between a minimum prevailing flow rate in the supply circuit and a minimum prevailing flow rate in the load circuit.

It may be that the mixing device is in the form of a tube.

It may be that the mixing device is generally elongate along the flow pathway. It may be that the inside diameter of the tube is at least 1.5 times larger than the largest diameter of the supply circuit inlet, the supply circuit outlet, the load circuit inlet and the load circuit outlet. It may be that the inside diameter of the tube is at least two times larger than the largest diameter of the supply circuit inlet, the supply circuit outlet, the load circuit inlet and the load circuit outlet, particularly when there are no space restrictions. This minimizes the pressure drop across the mixing device so that the supply circuit and the load circuit flow rates can be controlled independently of one another.

It may be that the load circuit comprises a bypass line for recirculation of coolant within the load circuit without passing through the mixing device.

It may be that the load circuit comprises a recirculation loop including the load pump, the cooling load heat exchanger and the bypass line, and excluding the mixing device.

It may be that the valve arrangement is configured to control the mix of coolant provided to the cooling load heat exchanger by controlling a split of flow received from the cooling load heat exchanger to (a) the bypass line and (b) the mixing device via a return line of the load circuit.

It may be that the heat exchange system is configured to operate in an high load flow condition in which a flow rate of the coolant flow provided to the cooling load heat exchanger is greater than a flow rate of coolant provided from the supply circuit to the mixing device, and in a low load flow condition in which the flow rate of the coolant flow provided to the cooling load heat exchanger is less than the flow rate of coolant provided from the supply circuit to the mixing device.

It may be that the valve arrangement is configured to operate in a partial bypass mode in which the coolant flow provided to the cooling load heat exchanger comprises a mix of (i) coolant from the supply circuit received via the mixing device and (ii) recirculated coolant from the load circuit via the bypass line. It may be that the valve arrangement is configured to operate in a full bypass mode in which the coolant flow provided to the cooling load heat exchanger consists of recirculated coolant from the load circuit. It may be that the valve arrangement is configured to operate in a full return mode in which the coolant flow provided to the cooling load heat exchanger consists of coolant received from the mixing device.

It may be that, in the partial bypass mode coolant flow provided to the cooling load heat exchanger comprises a mix of (i) coolant from the supply circuit received via the mixing device, (ii) recirculated coolant from the load circuit received via the bypass line and (iii) recirculated coolant from the load circuit received via the mixing device.

It may be that the heat exchanger is configured so that, when operating in the full return mode: there is a supply recirculation condition in the mixing device when a flow rate through the load pump is less than a flow rate of coolant provided to the mixing device from the supply circuit; and there is a load recirculation condition in the mixing device when a flow rate through the load pump is greater than a flow rate of coolant provided to the mixing device from the supply circuit.

It may be that the valve arrangement comprises a three-way valve configured to control a split of flow received from the cooling load heat exchanger to (i) the bypass line and (ii) the mixing device.

It may be that the heat exchange system comprises a controller configured to control the valve arrangement and/or the load pump to meet a cooling demand of the cooling load heat exchanger.

The controller may be configured to meet the cooling demand by controlling the valve arrangement and/or the load pump so that a monitored thermodynamic parameter associated with the load circuit or a heat source associated with the cooling load heat exchanger meets a primary target.

The primary target may be a value or range. The primary target may be a target temperature at a monitoring location associated with a heat source of the cooling load heat exchanger. The primary target may be a temperature (e.g. a set point temperature) of the heat source, for example a temperature of a component or a temperature-controlled environment or a process fluid to be cooled by the cooling load heat exchanger. The primary target may be a discharge temperature of the coolant flow through the cooling load heat exchanger (i.e. a temperature upon discharge of the coolant flow from the cooling load heat exchanger).

It may be that heat transfer at the cooling load heat exchanger is a function of a flow rate of the coolant flow provided to the cooling load heat exchanger and a temperature of the coolant flow provided to the cooling load heat exchanger. It may be that the controller is configured to control the valve arrangement and/or the load pump to meet a primary target associated with heat transfer at the cooling load heat exchanger meeting a cooling demand of the cooling load heat exchanger. It may be that the controller is configured to control the valve arrangement and/or the load pump to meet an auxiliary target associated with a property of the coolant flow provided to the heat exchanger. It may be that the controller is configured to control both the valve arrangement and the load pump to meet the primary target and the auxiliary target.

As the heat transfer at the cooling load heat exchanger is a function of a flow rate of the coolant flow provided to the cooling load heat exchanger and a temperature of the coolant flow provided to the cooling load heat exchanger, it may that there is a plurality of combinations of control settings for the load pump and the valve arrangement that would provide sufficient heat transfer to meet the cooling demand.

It may be that the controller comprises independent controllers for controlling the valve arrangement and the load pump respectively. For example, it may be that one of the controllers controls the load pump to meet the primary target, and the other of the controllers controls the valve arrangement to meet the auxiliary target.

It may be that the auxiliary target is defined to prevent excessive cooling at an upstream portion of the cooling load heat exchanger and/or excessive cooling of a component or portion of a component associated with an upstream portion of the cooling load heat exchanger.

It may be that the auxiliary target is a target temperature of the coolant flow provided to the cooling load heat exchanger.

The target temperature may be a minimum temperature, a temperature range between a minimum and maximum threshold, or a set-point. The temperature of the coolant flow provided to the cooling load heat exchanger is intended to refer to the temperature of the coolant flow at an inlet of the cooling load heat exchanger (i.e. as it is provided to the heat exchanger)

It may be that the heat exchange system comprises a cooling branch in the supply circuit in parallel and bypassing the mixing device, the cooling branch comprising a further cooling load heat exchanger.

It may be that the supply circuit is configured so that there is a branch point for providing flow into the cooling branch, wherein the branch point is upstream of the mixing device, and wherein there is a flow restriction device between the branch point and the mixing device configured so that a portion of flow circulating in the supply circuit flows through the cooling branch in preference to the mixing device.

It may be that the supply pump is a positive-displacement pump. It may be that the load pump is a positive-displacement pump.

According to a second aspect, there is provided a method of operating a heat exchange system in accordance with any preceding claim, comprising:
operating the supply pump to circulate coolant through the coolant supply heat exchanger and to provide coolant to the mixing device at a supply flow rate;
operating the load pump to circulate coolant through the cooling load heat exchanger at a cooling flow rate;
controlling the valve arrangement to vary a mix of (i) coolant from the supply circuit and (ii) recirculated coolant from the load circuit, in a coolant flow provided to the cooling load heat exchanger.

It may be that, in response to an increase in a cooling demand at the cooling load heat exchanger from a baseline operating state of the heat exchanger:
controlling the load pump to increase a flow rate of the coolant flow provided to the cooling load heat exchanger; and
controlling the valve arrangement to prevent a reduction of a temperature of the coolant flow provided to the cooling load heat exchanger.

It may be that the valve arrangement prevents a reduction of the temperature of the coolant flow provided to the cooling load heat exchanger by controlling a setting of the valve arrangement to maintain or reduce a proportion (i) coolant from the supply circuit in the mix of the coolant flow provided to the cooling load heat exchanger.

It may be that, in response to a decrease in a cooling demand at the cooling load heat exchanger from a baseline operating state of the heat exchanger:
controlling the load pump to reduce a flow rate of the coolant flow provided to the cooling load heat exchanger; and
controlling the valve arrangement to prevent a reduction of a temperature of the coolant flow provided to the cooling load heat exchanger

It may be that in the baseline operating state, the temperature of the coolant flow provided to the cooling load heat exchanger corresponds to a target or limit temperature to prevent excessive cooling at an upstream portion of the cooling load heat exchanger and/or excessive cooling of a component or portion of a component associated with an upstream portion of the cooling load heat exchanger. Accordingly, it may be that the control of the valve arrangement to prevent a reduction of the temperature of the coolant flow is to prevent the variation of the flow rate through the cooling load heat exchanger from causing the temperature to fall below the target or limit temperature.

It may be that the method comprises selectively controlling the valve arrangement to operate in: a partial bypass mode in which the coolant flow provided to the cooling load heat exchanger comprises a mix of (i) coolant from the supply circuit received via the mixing device and (ii) recirculated coolant from the load circuit via the bypass line.

It may be that the method comprises controlling the valve arrangement in the partial bypass mode to vary a split of flow received from the cooling load heat exchanger to (a) the bypass line and (b) the mixing device via the return line, to vary a proportion of coolant from the supply circuit in the coolant flow provided to the cooling load heat exchanger.

It may be that the method further comprises selectively controlling the valve arrangement to operate in:
a full return mode in which the coolant flow provided to the cooling load heat exchanger consists of coolant received from the mixing device; and/or
a full bypass mode in which the coolant flow provided to the cooling load heat exchanger consists of recirculated coolant from the load circuit.

It may be that the method comprises: operating the heat exchange system so that there is a supply recirculation condition in the mixing device, whereby at least a portion of coolant circulated by the supply pump follows a supply circuit recirculation loop extending through the mixing device. It may be that the method comprises operating the heat exchange system so that there is a load recirculation condition in the mixing device, whereby at least a portion of coolant circulated by the load pump follows a load circulation recirculation loop extending through the mixing device.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF DRAWINGS

Embodiments will now be described, by way of example only, with reference to the accompanying Figures, in which:

FIG. 1 schematically shows a first example heat exchange system;

FIG. 2 schematically shows a second example heat exchange system; and

FIG. 3 is a flow chart showing steps of a method of operating the second example heat exchange system.

### DETAILED DESCRIPTION

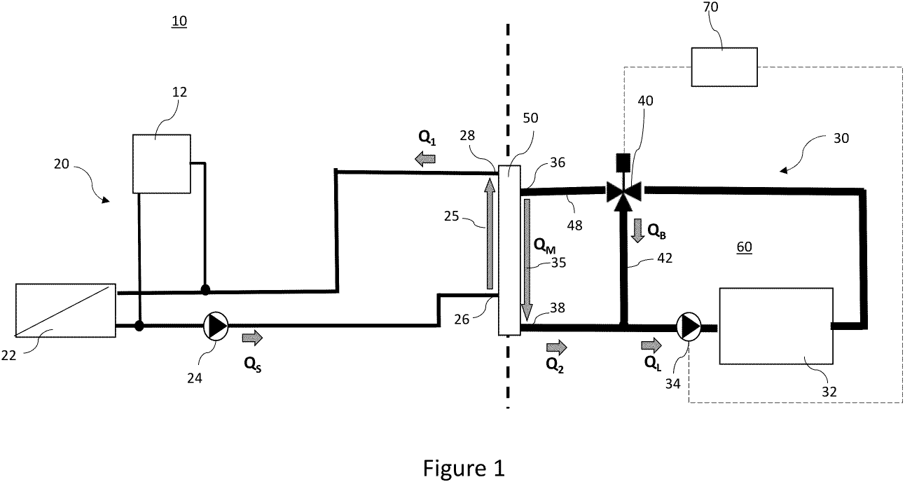

FIG. 1 shows a heat exchange system 10 for providing cooling to a load such as a car battery, by circulating coolant. The heat exchange system 10 comprises a supply circuit 20 for circulating the coolant, and a load circuit 30 for circulating the coolant. The heat exchange system 10 further comprises a mixing device 50 which is configured to form part of each of the supply circuit 20 and the load circuit 30. In other words, the supply circuit 20 and the load circuit 30 are joined by the mixing device 50.

The supply circuit 20 comprises a coolant supply heat exchanger 22 for rejecting heat from the coolant. Therefore, the output of the coolant supply heat exchanger 22 is configured to provide a supply of chilled coolant. The coolant supply heat exchanger 22 may be, for example, an evaporator of a refrigeration circuit.

The supply circuit 20 further comprises a supply pump 24 for circulating the coolant in the supply circuit 20. The supply circuit 20 also comprises an expansion tank 12 which has fluidic connections respectively upstream and downstream of the coolant supply heat exchanger 22, so that the expansion tank 12 is arranged in parallel with the coolant supply heat exchanger 22. One of the fluidic connections of the expansion tank 12 is disposed between the supply pump 24 and the coolant supply heat exchanger 22. The expansion tank 12 is configured to accommodate variable expansion due to temperature changes of the coolant in the supply circuit 20, and to bleed air from the system 10.

In this example, the mixing device 50 comprises a supply circuit inlet 26 for receiving chilled coolant from the supply circuit 20, and a supply circuit outlet 28 for providing coolant to the supply circuit 20 for recirculation to the coolant supply heat exchanger 22. The expression “coolant from the supply circuit” is intended to refer to coolant provided to the mixing device 50 from the coolant supply heat exchanger 22 (i.e., without intervening circulation through the load circuit 30). The flow rate of coolant through the supply circuit outlet 28 is defined as a minimum prevailing flow rate in the supply circuit, Q₁. The flow rate of coolant through the supply circuit outlet 28 is the same as the flow rate of coolant through the supply circuit inlet 26.

The load circuit 30 comprises a cooling load heat exchanger 32 configured to transfer heat to the coolant from a heat source (or load) which requires cooling, and a load pump 34 for circulating the coolant in the load circuit 30.

The load circuit 30 further comprises a valve arrangement 40 which is configured to control a mix of coolant from the supply circuit 20 and recirculated coolant from the load circuit 30, in the coolant flow provided to the cooling load heat exchanger 32.

In this example, the mixing device 50 comprises a load circuit inlet 36 for receiving coolant from the load circuit 30, and a load circuit outlet 38 for providing coolant to the load circuit 30 for heat transfer at the cooling load heat exchanger 32. The expression “coolant from the load circuit” or “recirculated coolant from the load circuit” is intended to refer to coolant provided from the cooling load heat exchanger 32 without intervening circulation through the supply circuit 20. The flow rate of coolant through the load circuit outlet 38 is defined as the minimum prevailing flow rate in the load circuit 30, Q₂. The flow rate of coolant through the load circuit inlet 36 is the same as the flow rate of coolant through the load circuit outlet 38, Q₂.

In this example, the mixing device 50 has a flow pathway between two opposing ends and is configured to permit flow in both directions along the flow pathway. In this example, the supply circuit inlet 26 and the load circuit outlet 38 are relatively closer to a first end of the mixing device 50, and the supply circuit outlet 28 and the load circuit inlet 36 are relatively closer to a second end of the mixing device 50, opposing the first end. In other examples, the inlets and outlets may be at any suitable locations on the mixing device.

In this example, a supply recirculation path 25 from the supply circuit inlet 26 to the supply circuit outlet 28 is along a first direction along the flow pathway. A load recirculation path 35 from the load circuit inlet 36 to the load circuit outlet 38 is along a second direction along the flow pathway, opposing the first direction. In this example, the supply recirculation path 25 and the load recirculation path 35 overlap along the flow pathway. This ensures that coolant drawn through the load circuit outlet 38 preferentially originates from the supply circuit inlet 26, up to a flow rate of coolant flowing through the supply circuit inlet 26, and coolant drawn through the supply circuit outlet 28 preferentially originates from the load circuit inlet 36, up to a flow rate of coolant flowing through the load circuit inlet 36. In other words, it ensures that coolant provided to the mixing device 50 from the supply circuit inlet 26 preferentially flows to the load circuit outlet 38, and coolant provided to the mixing device 50 from the load circuit inlet 36 preferentially flows to the supply circuit outlet 28.

In some examples, the mixing device may have any suitable configuration so that in use, coolant drawn through the load circuit outlet preferentially originates from the supply circuit inlet, up to a flow rate of coolant flowing through the supply circuit inlet and coolant drawn through the supply circuit outlet preferentially originates from the load circuit inlet. In other examples, the mixing device may have any suitable configuration which does not have this preferential flow arrangement.

In this example, the mixing device 50 is in the form of a tube. In other examples, the mixing device may be any suitable shape, such as a tank or accumulator. In some examples, the mixing device may be generally elongate along the flow pathway. In the form of a tube, the mixing device is relatively small and lightweight, and allows for rapid temperature change responses of the coolant delivered to the cooling load heat exchanger 32 when the valve arrangement 40 modifies the mix of coolant to the cooling load heat exchanger 32.

The mixing device 50 in the form of a tube has a low pressure drop between inlets 26, 36, and outlets 28, 38, which ensures that flow changes to the load circuit 30 will not affect flow in the supply circuit 20 and vice versa, thereby ensuring that the flow rates in the supply circuit 20 and the load circuit 30 can be independently controlled. In this example, the inside diameter of the tube of the mixing device 50 is at least 1.5 times larger than the largest inside diameter of the inlets 26, 36 and outlets 28, 38 of the mixing device 50. In other examples, the inside diameter of the tube of the mixing device 50 is at least two times larger than the largest inside diameter of the inlets 26, 36 and outlets 28, 38 of the mixing device 50. This ensures that the pressure drop across the mixing device 50 is low in comparison to the pressure drop in the supply circuit 20 and the load circuit 30.

In this example, the load circuit 30 further comprises a bypass line 42 for recirculating coolant within the load circuit 30 without passing through the mixing device 50. Therefore, in this example, the load circuit 30 comprises a bypass recirculation loop 60 including the load pump 34, the cooling load heat exchanger 32 and the bypass line 42, and excluding the mixing device 50. Parts of the load circuit 30 away from the load circuit outlet 38, such as in the bypass recirculation loop 60, may have a higher flow rate, Q_{L}, than the minimum prevailing flow rate, Q₂.

In this example, the valve arrangement 40 comprises a three-way valve 40 configured to control a split of flow received from the cooling load heat exchanger 32 to the bypass line 42 and to the mixing device 50 via a return line 48. In other examples, there may be any suitable valve arrangement configured to control the mix of coolant provided to the cooling load heat exchanger 32, for example, by controlling a split of flow received from the cooling load heat exchanger 32 to the bypass line 42 and to the mixing device 50 via the return line 48 of the load circuit 30.

In this example, the three-way valve 40 is disposed in the load circuit 30 upstream of the mixing device 50. In some examples, the three-way valve may be disposed downstream of the mixing device 50, and upstream of the load pump 34 (i.e., between the mixing device 50 and the load pump 34). In other examples, the three-way valve, or any suitable valve arrangement, may be disposed in the supply circuit 20 and may be configured to control a mix of coolant from the supply circuit and recirculated coolant from the load circuit, in a coolant flow provided to the cooling load heat exchanger.

The heat exchange system 10 further comprises a controller 70 which, in this example is configured to control the valve arrangement 40 and the load pump 34 to meet a cooling demand of the cooling load heat exchanger 32. In other examples, there may be multiple controllers which control the valve arrangement 40 and the load pump 34. In further examples, only one of the valve arrangement 40 and load pump 34 may be controlled.

In use, a load which is being cooled by the heat exchange system 10 may need to be cooled to a target temperature. The supply pump 24 is configured to pump coolant through the supply circuit 20, and the load pump 34 is configured to pump coolant through the load circuit 30. The load rejects heat to the cooling load heat exchanger 32, thereby heating the coolant, and the heated coolant is recirculated, with some chilled coolant being introduced from the supply circuit 20 via the mixing device 50, to chill the heated coolant.

In this example, in use, the heat exchange system 10 is configured to operate with a supply recirculation condition 25 in the mixing device 50, whereby at least a portion of coolant circulated by the supply pump 24 follows a supply circuit 20 recirculation loop extending through the mixing device 50 and whereby there is a net positive flow along the supply recirculation path 25 in the mixing device 50. The heat exchange system 10 in this example is also configured to operate with a load recirculation condition in the mixing device 50, whereby at least a portion of coolant circulated by the load pump 34 follows a load circuit recirculation loop extending through the mixing device 50, and whereby there is a net positive flow along the load recirculation path 35 in the mixing device 50.

In this example, the valve arrangement 40 is configured to operate in one of three different modes: a partial bypass mode, a full bypass mode and a full return mode. In the partial bypass mode, the coolant flow provided to the cooling load heat exchanger 32 comprises a mix of coolant from the supply circuit 20 received via the mixing device 50, recirculated coolant from the load circuit 30 received via the mixing device 50, and recirculated coolant from the load circuit 30 via the bypass line 42. In the full bypass mode, the coolant flow provided to the cooling load heat exchanger 32 consists solely of recirculated coolant from the load circuit 30, via the bypass line 42. In the full return mode, the coolant flow provided to the cooling load heat exchanger 32 consists solely of coolant received from the mixing device 50, including coolant from the supply circuit 20 and recirculated coolant from the load circuit 30 through the mixing device 50, such that there is no flow through the bypass line 42.

In the full return mode, there is a supply recirculation condition 25 in the mixing device 50 when the flow rate of coolant through the load pump, Q_{L=} Q₂, is less than the flow rate of coolant provided to the mixing device 50 from the supply circuit 20, Q₁ (i.e., when Q₂ < Q₁). In the full return mode, there is a load recirculation condition 35 in the mixing device 50 when the flow rate of coolant through the load pump, Q_{L} = Q₂, is greater than the flow rate of coolant provided to the mixing device 50 from the supply circuit 20, Q₁ (i.e., Q₂ > Q₁). This difference in flow rate is enabled by the mixing device 50.

The mixing device 50 therefore has a bidirectional portion for flow of coolant in either direction, and the flow rate and net flow direction, Q_{M}, along the bidirectional portion corresponds to a difference between the minimum prevailing flow rate in the supply circuit 20, Q₁, and the minimum prevailing flow rate in the load circuit 30, Q₂, (i.e., Q_{M} = Q₂ - Q₁).

When the flow rate of the coolant provided to the cooling load heat exchanger 32, Q_{L}, is higher than the flow rate of coolant provided from the supply circuit 20 to the supply circuit inlet 26, the heat exchange system 10 may be configured to operate in a high load flow condition. When the flow rate of the coolant provided to the cooling load heat exchanger 32, Q_{L}, is lower than the flow rate of coolant provided from the supply circuit 20 to the supply circuit inlet 26, the heat exchange system 10 may be configured to operate in a low load flow condition.

Due to the mixing device 50 and valve arrangement 40, the flow rate of coolant through the cooling load heat exchanger 32, Q_{L}, can be controlled independently of the flow rate of coolant through the coolant supply heat exchanger 22, Q_{S} = Q₁. This minimises the effects of hydraulic resistance from the coolant supply heat exchanger 22 on the cooling capacity of the cooling load heat exchanger 32, such that higher flow rates through the cooling load heat exchanger 32, Q_{L}, can be achieved.

Being able to independently control the coolant flow rate in the cooling load heat exchanger 32, Q_{L}, is particularly advantageous when the temperature of the chilled coolant provided to the mixing device 50 at the supply circuit inlet 26 is variable. Heat transfer at the cooling load heat exchanger 32 is a function of a flow rate of the coolant flow provided to the cooling load heat exchanger 32, Q_{L}, and a temperature of the coolant flow provided to the cooling load heat exchanger 32. When the coolant is too cold, a part of the load which rejects heat to an inlet of the cooling load heat exchanger 32 will reject more heat (and therefore be colder) than a part of the load which rejects heat to an outlet of the cooling load heat exchanger 32. If the whole load must be cooled to the target temperature, then the part of the load at the inlet of the cooling load heat exchanger 32 will be much colder than the target temperature which can be damaging to a load, such as a car battery. Being able to increase the flow rate of coolant through the cooling load heat exchanger 32 independently, means that the temperature difference across the load can be reduced (so that more even cooling is achieved across the load). By increasing the flow through inlet of the cooling load exchanger 32 and decreasing the inlet flow temperature the difference between the coolant temperature at the inlet and outlet of the cooling load heat exchanger 32 is reduced, whilst preserving total cooling capacity is still preserved.

In this example, the controller 70 is configured meet the cooling demand of the cooling load heat exchanger 32 by controlling the valve arrangement 40 and the load pump 34 so that a monitored thermodynamic parameter associated with the load circuit 30 or a heat source (load) associated with the cooling load heat exchanger 32 meets a primary target associated with heat transfer at the cooling load heat exchanger 32. The primary target may be a value or a range. It may be a temperature at a monitoring location associated with a heat source (load) of the cooling load heat exchanger 32. The primary target may be a temperature (e.g., a set point temperature) of the heat source, for example a temperature of a component or a temperature-controlled environment or a process fluid to be cooled by the cooling load heat exchanger 32. The primary target may be a discharge temperature of the coolant flow through the cooling load heat exchanger 32 (i.e., a temperature upon discharge of the coolant flow from the cooling load heat exchanger 32). For example, the heat exchange system may comprise a sensor, such as a temperature or pressure sensor, for sensing a thermodynamic property of the coolant at the outlet of the cooling load heat exchanger 32 or a thermodynamic property of the load, and the sensor may output a reading to the controller 70, which then controls the valve arrangement 40 and the load pump 34 to meet the primary target.

In this example, the controller 70 is also configured to meet an auxiliary target associated with a property of the coolant flow provided to the cooling load heat exchanger. For example, the auxiliary target may be a target temperature of the coolant flow provided to the cooling load heat exchanger 32. For example, the heat exchange system may comprise a sensor, such as a temperature or pressure sensor, for sensing a thermodynamic property of the coolant at the inlet of the cooling load heat exchanger 32 or a thermodynamic property of the load at the inlet of the cooling load heat exchanger 32, and the sensor may output a reading to the controller 70, which then controls the valve arrangement 40 and the load pump 34 to also meet the auxiliary target.

The auxiliary target may be defined to prevent excessive cooling at the inlet or an upstream portion of the cooling load heat exchanger 32. It may be defined to prevent excessive cooling of a component or portion of a component associated with an upstream portion of the cooling load heat exchanger 32. The target temperature may be a minimum temperature, a set-point temperature or a set range between a maximum threshold and minimum threshold.

As the heat transfer at the cooling load heat exchanger 32 is a function of a flow rate of the coolant flow provided to the cooling load heat exchanger 32, Q_{L}, and a temperature of the coolant flow provided to the cooling load heat exchanger 32, there may be a plurality of combinations of control settings for the load pump 34 and the valve arrangement 40 that would provide sufficient heat transfer to meet the cooling demand. This may be achieved with a single controller 70 or a more than one controller. For example, with more than one controller, one of the controllers may control the load pump 34 to meet the primary target, and the other of the controllers may control the valve arrangement 40 to meet the auxiliary target.

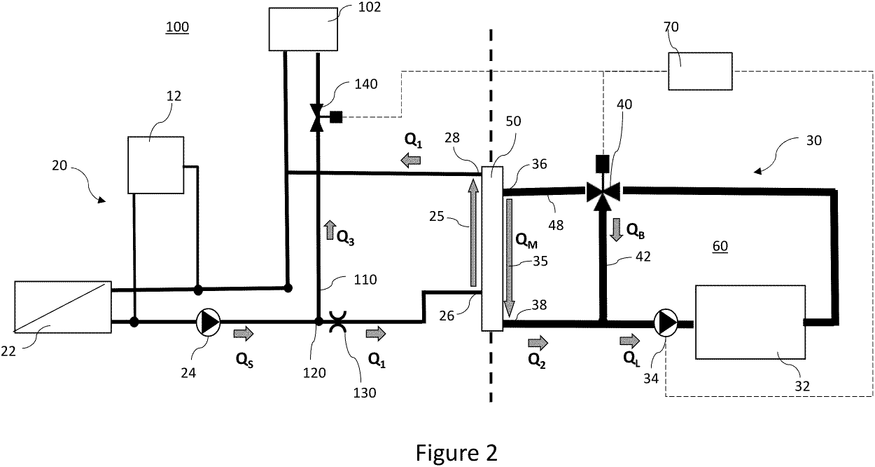

FIG. 2 shows a second example heat exchange system 100 which is substantially similar to the first example heat exchange system 10 with like reference numerals denoting like parts. The second example heat exchange system 100 differs from the first example heat exchange system 10 in that it comprises a cooling branch 110 in the supply circuit 20 which branches from the line between the supply pump 24 and the supply circuit inlet 26 of the mixing device 50 at a branch point 120 (i.e., the branch point 120 is upstream of the mixing device 50), and returns to a line in the supply circuit 20 between the coolant supply heat exchanger 22 and the supply circuit outlet 28 of the mixing device 50 (i.e., downstream of the mixing device 50). The cooling branch 110 is therefore in parallel with, and bypassing, the mixing device 50. In this example, the cooling load heat exchanger 32 in the load circuit 30 is a first cooling load heat exchanger 32, and the cooling branch 110 comprises a second cooling load heat exchanger 102, in the supply circuit 20.

In this example, there is a flow restriction device 130 between the branch point 120 and the mixing device 50 (i.e., between the branch point 120 and the supply circuit inlet 26) configured so that a portion of the flow circulating in the supply circuit 20 flows through the cooling branch 110 and the rest to the mixing device 50. A second valve arrangement 140 is configured to control flow through the cooling branch 110, and is controlled by the controller 70.

Due to the separation of the supply circuit 20 and the load circuit 30, as well as the mixing device 50 and the valve arrangements 40, 140, the flow rate of coolant through the first cooling load heat exchanger 32, Q_{L}, can be controlled independently of the flow rate of coolant through the second cooling load heat exchanger 102, Q₃, so that each load or heat source can be cooled independently, as required. The supply circuit 20 may also comprise sensors at the second cooling load heat exchanger 102 similar to the sensors at the first cooling load heat exchanger 32.

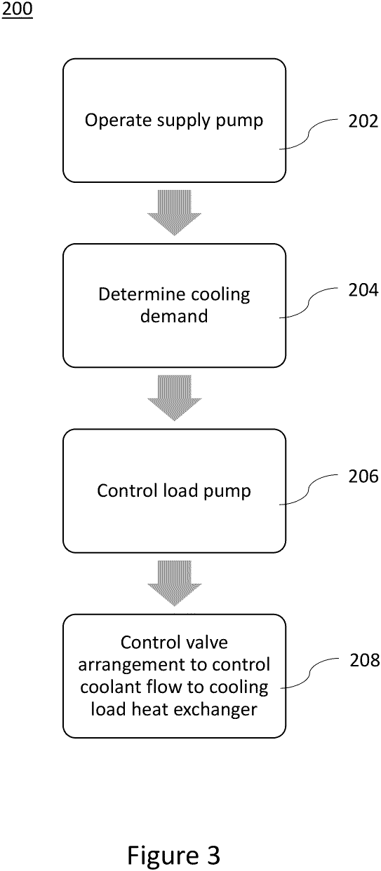

FIG. 3 is a flow chart showing steps of a method 200 of controlling a heat exchange system, such as the first example heat exchange system 10 or the second example heat exchange system 100.

In block 202, the method 200 comprises operating the supply pump 24 to circulate coolant through the coolant supply heat exchanger 22 and to provide coolant to the mixing device 50 at a supply flow rate, Q_{S} which may be equal to Q₁.

In block 204, the method 200 comprises determining a cooling demand at the cooling load heat exchanger 32, 102. The cooling demand may be from a baseline operating state of the respective cooling load heat exchanger 32, 102. The baseline operating state may be the temperature of the coolant flow provided to the cooling load heat exchanger 32 corresponding to a target or limit temperature to prevent excessive cooling at an upstream portion of the cooling load heat exchanger 32 and/or excessive cooling of a component or portion of a component associated with an upstream portion of the cooling load heat exchanger 32.

Determining a cooling demand at the cooling load heat exchanger may comprise, for example, determining a thermodynamic property associated with the heat source (load) heat source which is cooled by the cooling load heat exchanger, such as the temperature of the heat source or the temperature of the coolant at an outlet of the cooling load heat exchanger 32, 102.

In block 206, the method 200 comprises operating the load pump 34 to circulate coolant through the cooling load heat exchanger 32 at a cooling flow rate, Q_{L}.

In block 208, the method 200 comprises controlling the valve arrangement 40 to vary the mix of cooling from the supply circuit 20 and recirculated coolant from the load circuit 30, in a coolant flow provided to the cooling load heat exchanger 32.

When the cooling load heat exchanger 32 is already at a baseline operating state (e.g., the coolant provided at the inlet of the cooling load heat exchanger 32 is already at a minimum or limit temperature), the valve arrangement 40 can be controlled to ensure that the temperature of the coolant does not reduce further, when the flow rate through the cooling load heat exchanger 32 is changed. Accordingly, the control of the valve arrangement 40 may be configured to prevent a reduction of the temperature of the coolant flow is to prevent the variation of the flow rate through the cooling load heat exchanger 32 from causing the temperature to fall below the target or limit temperature.

In this example, the valve arrangement 40 can be controlled to operate selectively in the partial bypass mode, the full bypass mode and/or the full return mode. In the partial bypass mode, the method 200 may comprise controlling the valve arrangement 40 to vary a split of flow received from the cooling load heat exchanger 32 to the bypass line 42 and the mixing device 50 via the return line 48, to vary a proportion of coolant from the supply circuit 20 in the coolant flow provided to the cooling load heat exchanger 32.

The method 200 may also comprise operating the heat exchange system 10, 100 by controlling the valve arrangement 40 and the load pump 34 so that there is a supply recirculation condition in the mixing device 50 or operating the heat exchange system 10, 100 by controlling the valve arrangement 40 and the load pump 34 so that there is a load recirculation condition in the mixing device 50.

In an example in which the valve arrangement 40 is operating in a partial bypass mode, such that the heat exchange system 10, 100 is operated in a supply recirculation condition, the proportion of flow through the bypass line 42 and the return line 48 affects the temperature of the coolant supplied to the cooling load heat exchanger 32, without affecting the flow rate of the flow to the cooling load heat exchanger 32, Q_{L}. When the valve arrangement 40 is operating in a partial bypass mode, such that the heat exchange system 10, 100 is operated in a load recirculation condition, varying the proportion of flow through the bypass line 42 and the return line 48 has no effect on the temperature of the coolant provided to the cooling load heat exchanger 32.

In this example, blocks 206 and 208 are based on the determined cooling demand. For example, in response to an increase in cooling demand at the cooling load heat exchanger 32 from a baseline operating state of the heat exchanger, the method 200 may comprise controlling the load pump 34 to increase a flow rate of the coolant flow provided to the cooling load heat exchanger, and may control the valve arrangement 40 to prevent a reduction of a temperature of the coolant flow provided to the cooling load heat exchanger 32. In response to a decrease in cooling demand at the cooling load heat exchanger 32 from a baseline operating state of the heat exchanger, the method 200 may comprise controlling the load pump 34 to reduce a flow rate of the coolant flow provided to the cooling load heat exchanger, and may control the valve arrangement 40 to prevent a reduction of a temperature of the coolant flow provided to the cooling load heat exchanger 32. In other examples, the control may be based on any suitable condition.

The method 200 may prevent a reduction of the temperature of the coolant flow provided to the cooling load heat exchanger by controlling a setting of the valve arrangement 40 to maintain or reduce a proportion of coolant from the supply circuit in the mix of the coolant flow provided to the cooling load heat exchanger.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A heat exchange system for providing cooling by circulating a coolant, the heat exchange system comprising:
a supply circuit for circulating the coolant comprising:
a coolant supply heat exchanger for rejecting heat from the coolant to provide a supply of chilled coolant;
a supply pump for circulating the coolant in the coolant supply circuit; a load circuit for circulating the coolant, comprising:
a cooling load heat exchanger configured to transfer heat to the coolant;
a load pump for circulating the coolant in the load circuit;
a mixing device which is configured to form part of each of the supply circuit and the load circuit; and
a valve arrangement configured to control a mix of (i) coolant from the supply circuit and (ii) recirculated coolant from the load circuit, in a coolant flow provided to the cooling load heat exchanger.

2. The heat exchange system of claim 1, wherein the mixing device comprises:
a supply circuit inlet for receiving chilled coolant from the supply circuit;
a supply circuit outlet for providing coolant to the supply circuit for recirculation to the coolant supply heat exchanger;
a load circuit inlet for receiving coolant from the load circuit;
a load circuit outlet for providing coolant to the load circuit for heat transfer at the cooling load heat exchanger.

3. The heat exchange system of claim 2, wherein the mixing device is configured so that in use at least one of:
coolant drawn through the load circuit outlet preferentially originates from the supply circuit inlet, up to a flow rate of coolant flowing through the supply circuit inlet; and
coolant drawn through the supply circuit outlet preferentially originates from the load circuit inlet.

4. The heat exchange system of claim 2, wherein the mixing device has a flow pathway between two opposing ends and is configured to permit flow in both directions along the flow pathway;
wherein a supply recirculation path from the supply circuit inlet to the supply circuit outlet is along a first direction along the flow pathway; and
wherein a load recirculation path from the load circuit inlet to the load circuit outlet is along a second direction along the flow pathway;
and wherein the supply recirculation path and the load recirculation flow path overlap along the flow pathway.

5. The heat exchange system of claim 2, wherein the mixing device has a flow pathway between two opposing ends, wherein the supply circuit inlet and the load circuit outlet are relatively closer to a first end, and wherein the supply circuit outlet and the load circuit inlet are relatively closer to the opposing second end.

6. The heat exchange system of claim 1, wherein the mixing device is in the form of a tube.

7. The heat exchange system of claim 1, wherein the load circuit comprises a bypass line for recirculation of coolant within the load circuit without passing through the mixing device.

8. The heat exchange system of claim 7, wherein the valve arrangement is configured to control the mix of coolant provided to the cooling load heat exchanger by controlling a split of flow received from the cooling load heat exchanger to (a) the bypass line and (b) the mixing device via a return line of the load circuit.

9. The heat exchange system of claim 7, wherein the valve arrangement is configured to at least one of:
operate in a partial bypass mode in which the coolant flow provided to the cooling load heat exchanger comprises a mix of (i) coolant from the supply circuit received via the mixing device and (ii) recirculated coolant from the load circuit via the bypass line;
operate in a full bypass mode in which the coolant flow provided to the cooling load heat exchanger consists of recirculated coolant from the load circuit;
operate in a full return mode in which the coolant flow provided to the cooling load heat exchanger consists of coolant received from the mixing device.

10. The heat exchange system of claim 7, wherein the valve arrangement comprises a three-way valve configured to control a split of flow received from the cooling load heat exchanger to (i) the bypass line and (ii) the mixing device.

11. The heat exchange system of claim 1, comprising a controller configured to control at least one of the valve arrangement and the load pump to meet a cooling demand of the cooling load heat exchanger.

12. The heat exchange system of claim 11, wherein heat transfer at the cooling load heat exchanger is a function of a flow rate of the coolant flow provided to the cooling load heat exchanger and a temperature of the coolant flow provided to the cooling load heat exchanger;
wherein the controller is configured to control at least one of the valve arrangement and the load pump to meet a primary target associated with heat transfer at the cooling load heat exchanger meeting a cooling demand of the cooling load heat exchanger;
wherein the controller is configured to control at least one of the valve arrangement and the load pump to meet an auxiliary target associated with a property of the coolant flow provided to the heat exchanger;
wherein the controller is configured to control both the valve arrangement and the load pump to meet the primary target and the auxiliary target.

13. The heat exchange system of claim 12, wherein the auxiliary target is a target temperature of the coolant flow provided to the cooling load heat exchanger.

14. The heat exchange system of claim 1, comprising a cooling branch in the supply circuit in parallel and bypassing the mixing device, the cooling branch comprising a further cooling load heat exchanger.

15. The heat exchange system of claim 14, wherein the supply circuit is configured so that there is a branch point for providing flow into the cooling branch, wherein the branch point is upstream of the mixing device, and wherein there is a flow restriction device between the branch point and the mixing device configured so that a portion of flow circulating in the supply circuit flows through the cooling branch in preference to the mixing device.

16. A method of operating a heat exchange system having a supply circuit and a load circuit, comprising:
operating a supply pump of the supply circuit to circulate coolant in the supply circuit including through a coolant supply heat exchanger to reject heat from the coolant, and to provide coolant to a mixing device at a supply flow rate, the mixing device forming a part of each of the supply circuit and the load circuit;
operating a load pump of the load circuit to circulate coolant in the load circuit including through a cooling load heat exchanger at a cooling flow rate;
controlling a valve arrangement to vary a mix of (i) coolant from the supply circuit and (ii) recirculated coolant from the load circuit, in a coolant flow provided to the cooling load heat exchanger.

17. The method of claim 16 comprising, in response to an increase in a cooling demand at the cooling load heat exchanger from a baseline operating state of the heat exchanger:
controlling the load pump to increase a flow rate of the coolant flow provided to the cooling load heat exchanger; and
controlling the valve arrangement to prevent a reduction of a temperature of the coolant flow provided to the cooling load heat exchanger.

18. The method of claim 16 comprising, in response to a decrease in a cooling demand at the cooling load heat exchanger from a baseline operating state of the heat exchanger:
controlling the load pump to reduce a flow rate of the coolant flow provided to the cooling load heat exchanger; and
controlling the valve arrangement to prevent a reduction of a temperature of the coolant flow provided to the cooling load heat exchanger.

19. The method of claim 16, wherein the valve arrangement is configured to control the mix of coolant provided to the cooling load heat exchanger by controlling a split of flow received from the cooling load heat exchanger to (a) the bypass line and (b) the mixing device via a return line of the load circuit;
wherein the method further comprises selectively controlling the valve arrangement to operate in:
a partial bypass mode in which the coolant flow provided to the cooling load heat exchanger comprises a mix of (i) coolant from the supply circuit received via the mixing device and (ii) recirculated coolant from the load circuit via the bypass line.

20. The method of claim 19, comprising:
the valve arrangement operating in a partial bypass mode in which the coolant flow provided to the cooling load heat exchanger comprises a mix of (i) coolant from the supply circuit received via the mixing device and (ii) recirculated coolant from the load circuit via the bypass line;
controlling the valve arrangement in the partial bypass mode to vary a split of flow received from the cooling load heat exchanger to (a) the bypass line and (b) the mixing device via the return line, to vary a proportion of coolant from the supply circuit in the coolant flow provided to the cooling load heat exchanger.
